(19) United States
(12) Patent Application Publication
(10) Pub. No.: US 2006/0256300 A1
(43) Pub. Date: Nov. 16, 2006

(54) Color wheel

(76) Inventors: Ke-Shu Chin, Jhonghe City (TW); Chih-Neng Chang, Taipei (TW); Chien-Fu Chen, Taipei County (TW)

Correspondence Address: BIRCH STEWART KOLASCH & BIRCH, PO BOX 747, FALLS CHURCH, VA, 22040-0747, US

(21) Appl. No.: 11/488,083

(22) Filed: Jul. 18, 2006

Related U.S. Application Data
(62) Division of application No. 10/952,860, filed on Sep. 30, 2004.

(51) Int. Cl. G03B 21/28

(52) U.S. Cl. 353/81

(57) ABSTRACT

A color wheel includes a motor, a color filter, and a fan blade assembly. In this case, the motor has a housing and a motor body, and the housing is set to a side of the motor body. The housing and the motor body rotate around a central axis. The color filter is set on the housing. The fan blade assembly has a plurality of blades and the fan blade assembly is set on the color filter.

### BACKGROUND OF THE INVENTION

1. Field of Invention

The invention relates to a color wheel and more particularly, this invention relates to a color wheel, which is used in a projection system.

2. Related Art

Currently, image projection systems have become popular items in the optoelectronic industry owing to multiple requirements of the system having large display area, small dimension, and thin, light composition.

The present projection systems are divided into three types including a liquid crystal display (LCD) type, a liquid crystal on silicon (LCoS) type, and a digital light processing (DLP) type, wherein the single-panel LCoS and DLP types advantageously have simplified systems and the following description will take the DLP type as an example.

In a DLP projector, a digital control method and a reflection principle are adopted. First, light rays are integrated or converged by a light integration rod and then pass through a color filter of a color wheel, which splits the light rays. The split light rays are then projected onto a digital micro-mirror device (DMD). In this technology, the DMD is used to replace the liquid crystal panel for representing images in the conventional liquid crystal projector. Since the DMD includes several movable micro-mirrors, driving electrodes may control the tilt angle and deflection time of each movable mirror. Then, the light rays may be projected to form an image by switching the reflection directions of the light rays.

In this case, the color wheel is made of color filter adhered to the motor with an adhesive. The motor rotation causes the color filter rotation around the central axis. However, the temperature of the light source in the system is always high to 950 to 1000° C., so the temperature of the system is also high. The adhesive is easily fragile under high temperature. Thus, the high temperature caused by the light source not only shortens the life span of the color wheel, but also affects the reliability of other elements.

To solve the above-mentioned problem, the present method is to set a fan near the light source, color wheel and DMD. The wind produced by the fan is used to lower the temperature of the environment and the elements. However, the design of the electric devices goes toward minimization and portability. If a fan were added in the conventional system, the volume and the weight of the system would be increased.

It is therefore a subjective of the invention to provide a color wheel to solve the above-mentioned problems.

### SUMMARY OF THE INVENTION

In view of the foregoing, the invention is to provide a color wheel, which may have the advantages of solving the high-temperature problem of the projection system.

To achieve the above, a color wheel of the invention includes a motor, a color filter and a fan blade assembly. In this invention, the motor has a housing and a motor body, and the housing is set to one side of the central axis of the motor body. The housing and the motor body rotate around a central axis. The color filter is set on the housing. The fan blade assembly has a plurality of blades and the fan blade assembly is set on the color filter.

To achieve the above, a color wheel of the invention includes a motor, a color filter and a fan blade assembly. In this invention, the motor has a housing and a motor body, and the housing is set to one side of the central axis of the motor body. The housing and the motor body rotate around a central axis. The color filter is set on the housing. The fan blade assembly has a plurality of blades, and the fan blade assembly is set around the motor.

To achieve the above, a color wheel of the invention includes a motor, a color filter and a fan blade assembly. In this invention, the motor has a housing and a motor body, and the housing is set to one side of the central axis of the motor body. The housing and the motor body rotate around a central axis. The fan blade assembly has a plurality of blades. The fan blade assembly is connected to the motor, and the color filter is connected to the fan blade assembly.

As mentioned above, the color wheel of the invention has a fan blade assembly. The fan blade assembly rotates to disperse the heat inside the projection system or to conduct the heat to the outside of the system. Comparing to the conventional system, the fan blade assembly is added to the color wheel in the invention. The motor rotation leads to the rotation of the color filter and the rotation of the fan blade assembly. Since there is no additional external fan added, the volume of the system remains the same, and the weight of the system increases slightly. Further, the convection caused by the fan blade assembly lowers the temperature of the motor and prolongs the lifetime of the color wheel. In addition, the lower temperature of the whole system also increases the reliability of other elements.

### BRIEF DESCRIPTION OF THE DRAWINGS

The invention will become more fully understood from the detailed description given hereinbelow illustration only, and thus is not limitative of the present invention, and wherein:

FIG. 1A is a schematic illustration that shows a side view of a color wheel in accordance with an embodiment of the invention;

FIG. 1B is a schematic illustration that shows a top view of a color wheel in accordance with an embodiment of the invention;

FIG. 2A is a schematic illustration that shows a cross-sectional view of a color wheel in accordance with an embodiment of the invention;

FIG. 2B is a schematic illustration that shows a top view of a color wheel in accordance with an embodiment of the invention;

FIG. 3 is a schematic illustration that shows a top view of a color wheel in accordance with another embodiment of the invention;

FIG. 4 is a schematic illustration that shows a cross-sectional view of a color wheel in accordance with another embodiment of the invention;

FIG. 5 is a schematic illustration that shows a side view of a color wheel in accordance with another embodiment of the invention; and

FIG. 6 and FIG. 7 are other schematic illustrations that show a side view of a color wheel in accordance with yet another embodiment of the invention.

### DETAILED DESCRIPTION OF THE INVENTION

The present invention will be apparent from the following detailed description, which proceeds with reference to the accompanying drawings, wherein the same references relate to the same elements.

A color wheel 1 according to an embodiment of the invention includes a motor 11, a color filter 12 and a fan blade assembly 13. Wherein, the motor 11 has a housing 111 and a motor body 112, and the housing 111 is set to a side of the motor body 112. The housing 111 and the motor body 112 rotate around a central axis A. The color filter 12 is set on the housing 111. The fan blade assembly 13 has a plurality of blades 131 and is set on the color filter 12.

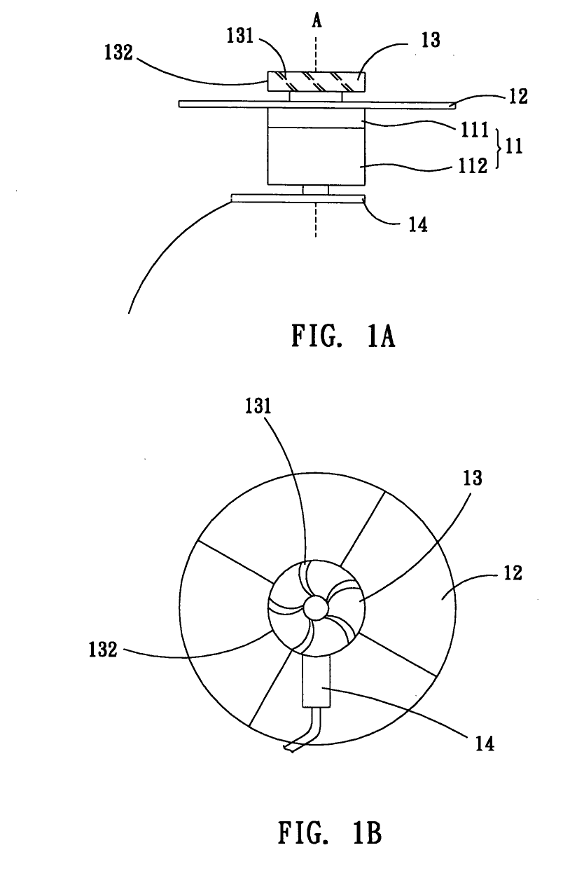

Referring to FIG. 1A and FIG. 1B, the motor 11 has the housing 111 and the motor body 112, and the housing 111 is set to a side of the motor body 112. The housing 111 and the motor body 112 rotate around a central axis A. In the embodiment, the motor body 112 is mainly composed of a shell (not shown), a magnetic ring (not shown), a laminated steel stack (not shown) and a coil (not shown). When the coil is powered on, the laminated steel stack produces a magnetic force and a magnetic field. Controlling the positive/negative property and the intensity of the flowing current may change the magnetic field in sequence, or produce a rotating magnetic field, to interact with the magnetic ring and thus cause the magnetic ring to rotate.

The color filter 12 may be a circular filter or a ring-shaped filter composed of a red sector section, a green sector section, and a blue sector section. Alternatively, the color filter 12 also may be a circular filter or a ring-shaped filter composed of a red sector section, a green sector section, a blue sector section, and a transparent sector section. Of course, as shown in FIG. 1B, the color filter 12 also may be a ring-shaped transparent plate or a circular transparent plate, on which at least a red film, at least a green film, and at least a blue film are formed.

In the embodiment, the color filter 12 is set on the housing 111 of the motor 11. Herein, the color filter 12 is set on the housing 111 by way of, for example, a fitting, adhering process or placing the color filter 12 over the housing 111. The color filter 12 rotates around the central axis A.

Referring to FIG. 1A and FIG. 1B again, the color filter 12 is between the motor 11 and the fan blade assembly 13. The fan blade assembly 13 has a plurality of blades 131, and the blades 131 can be made of engineering plastic, rubber, metal, carbon fiber, ceramics, wood or composite materials. In addition, as shown in FIG. 1A and FIG. 1B, the fan blade assembly 13 can include a casing 132 for connecting to the color filter 12. In the embodiment, the size and the shape of the fan blade assembly 13 and the blades 131 can be adjusted in accordance with practical needs. Herein, the fan blade assembly 13 is circular or ring-shaped, and the fan blade assembly 13 rotates around the central axis A.

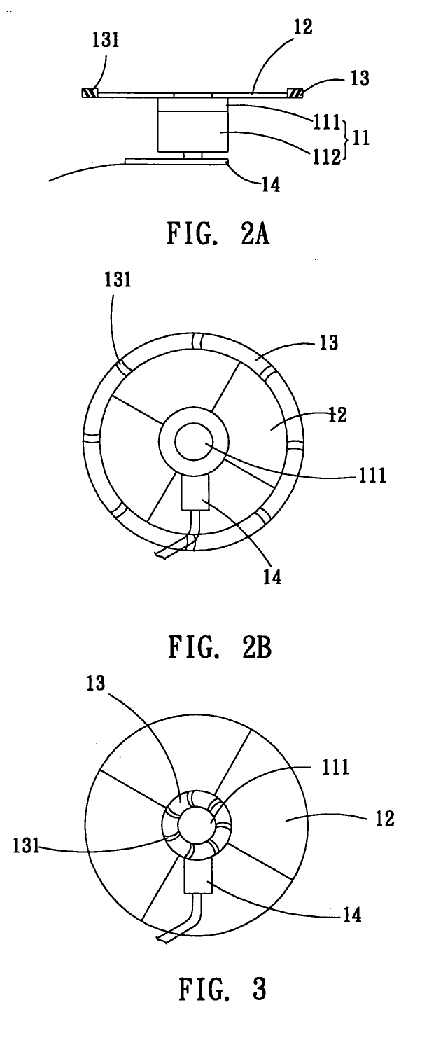

Besides, referring to FIG. 2A and FIG. 2B, the fan blade assembly 13 can be set around the color filter 12. Herein, the fan blade assembly 13 is ring-shaped.

Furthermore, referring to FIG. 3, the fan blade assembly 13 can be ring-shaped and set on the color filter 12.

Referring to FIG. 1A again, in the embodiment, the color wheel 1 can further include a fixing element 14. The fixing element 14 is a fixing plate for fixing the color wheel 1 in a projection system.

In the embodiment, the rotation of the motor 11 leads to the rotation of the color filter 12 and the rotation of the fan blade assembly 13. The convection caused by the fan blade assembly 13 can disperse the heat inside the system and can dissipate the heat to the outside of the system when there is an opening on the projection system to lower the temperature of the internal of the system and to prolong the lifetime of the color wheel 1.

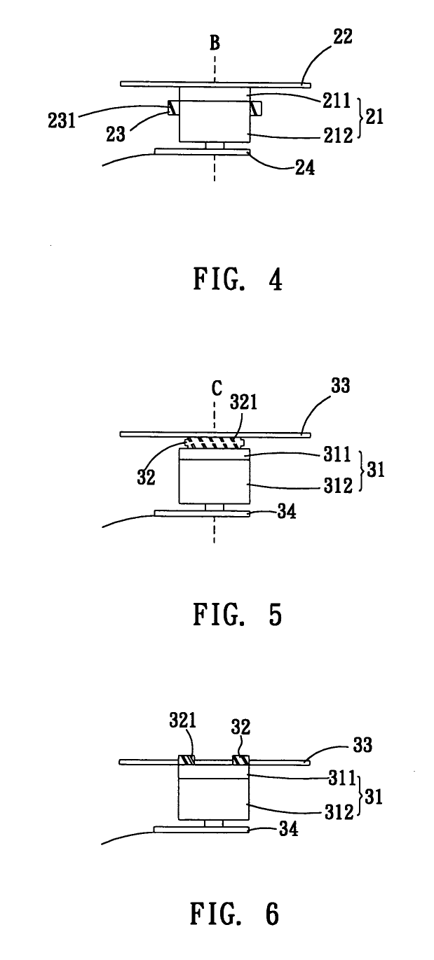

Please refer to FIG. 4. In another embodiment, a color wheel 2 according to the embodiment of the invention includes a motor 21, a color filter 22 and a fan blade assembly 23, wherein the motor 21 has a housing 211 and a motor body 212, and the housing 211 is set to a side of the motor body 212. The housing 211 and the motor body 212 rotate around a central axis B. The color filter 22 is set on the housing 211. The fan blade assembly 23 has a plurality of blades 231 and the fan blade assembly 23 is set around the motor 21.

In this embodiment, the color wheel 2 can further include a fixing element 24. The fixing element 24 is a fixing plate for fixing the color wheel 2 in a projection system.

In this embodiment, the fan blade assembly 23 rotates around the central axis B, and the color filter 22 also rotates around the central axis B.

The features and the functions of the elements in this embodiment are same as those in the embodiment described previously, so the detailed descriptions are omitted here for concise purposes.

In yet another embodiment, the color wheel 3 includes a motor 31, a fan blade assembly 32 and a color filter 33, wherein the motor 31 has a housing 311 and a motor body 312, and the housing 311 is set to a side of the motor body 312. The housing 311 and the motor body 312 rotate around a central axis C. The fan blade assembly 32 has a plurality of blades 321 and is connected to the motor 31. The color filter 33 is connected to the fan blade assembly 32.

In yet another embodiment, the color wheel 3 includes a motor 31, a fan blade assembly 32 and a color filter 33, wherein the motor 31 has a housing 311 and a motor body 312, and the housing 311 is set to a side of the motor body 312. The housing 311 and the motor body 312 rotate around a central axis C. The fan blade assembly 32 has a plurality of blades 321 and is connected to the motor 31. The color filter 33 is connected to the fan blade assembly 32.

In this embodiment, the color wheel 3 can further include a fixing element 34. The fixing element 34 is a fixing plate for fixing the color wheel 3 in a projection system.

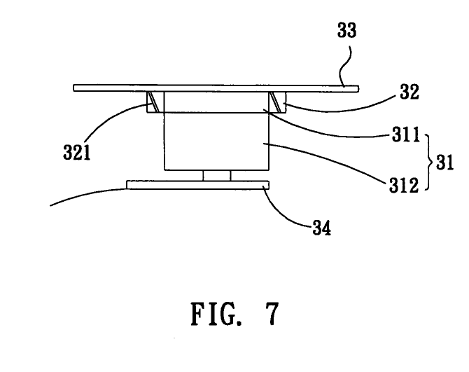

Referring to FIG. 5, the fan blade assembly 32 is set between the color filter 33 and the motor 31. In addition, referring to FIG. 6, the color filter 33 can also be set around the fan blade assembly 32. Moreover, referring to FIG. 7, the fan blade assembly 32 is set around the motor 31.

Additionally, in this embodiment, the fan blade assembly 32 rotates around the central axis C and the color filter 33 also rotates around the central axis C.

The features and the functions of the elements in this embodiment are same as those in the embodiment mentioned above, so the detailed descriptions are omitted here for concise purposes.

In addition, in this embodiment, the fan blade assembly 32 can increase the contact area between the motor 31 and the color filter 33.

In summary, the color wheel of the invention has a fan blade assembly. By rotating the fan blade assembly, the heat of the projection system can be dispersed and dissipated to the external of the system. Comparing to the conventional system, only the fan blade assembly is added to the color wheel of the invention. The rotation of the motor leads to the rotation of the color filter and the fan blade assembly. Since no additional fan is needed, the volume of the system remains the same, and the weight of the system and the production cost increase only slightly. Therefore, it is suitable for industrial use. Furthermore, the convection caused by the fan blade assembly lowers the temperature of the motor to prolong the lifetime of the color wheel. Moreover, the lower temperature of the system increases the reliability of other elements.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A color wheel, comprising:
a motor including a housing and a motor body, wherein the housing and the motor body rotate around a central axis, and the housing is set to one side of the motor body;
a fan blade assembly including a plurality of blades and connecting to the motor; and
a color filter connecting to the fan blade assembly.

2. The color wheel according to claim 1, wherein the fan blade assembly is set between the color filter and the motor.

3. The color wheel according to claim 1, wherein the fan blade assembly rotates around the central axis.

4. The color wheel according to claim 1, wherein the color filter rotates around the central axis.

5. The color wheel according to claim 1, wherein the blades are made of engineering plastic, rubber, metal, carbon fiber, ceramics, wood or composite materials.
